(19) United States
(12) Patent Application Publication
(10) Pub. No.: US 2025/0136818 A1
(43) Pub. Date: May 1, 2025

(54) RESIN ADDITIVE, INORGANIC-PARTICLE-CONTAINING RESIN COMPOSITION, AND PRODUCTION METHODS THEREFOR

(71) Applicant: MIKASA SANGYO CO., LTD., Yamaguchi (JP)

(72) Inventors: Osamu NOGAMI, Yamaguchi (JP); Haruka INO, Yamaguchi (JP); Hideo MAE, Yamaguchi (JP); Shogo MIYAZAKI, Yamaguchi (JP)

(21) Appl. No.: 18/836,096

(22) PCT Filed: Dec. 16, 2022
(86) PCT No.: PCT/JP2022/046348

§ 371 Date: Oct. 2, 2024

(30) Foreign Application Priority Data
Feb. 8, 2022 (JP) 2022-017809

(51) Int. Cl. C09C 3/08; C08K 3/22; C08K 3/28; C08K 3/38; C08K 9/04

(52) U.S. Cl. CPC C09C 3/08; C08K 3/28; C08K 9/04; C08K 2003/222; C08K 2003/282; C08K 2003/385

(57) ABSTRACT

To provide a method for producing a resin additive with which inorganic particles can be incorporated in large amounts into resins and which has satisfactory flowability even when having a high inorganic-particle content and can improve thermal conductivity and lower water absorption. A method for producing a resin additive comprising a mixing step in which inorganic particles, an organic acid, and a pH adjusting agent are mixed together to obtain a mixture having a pH of 5-9, a pretreatment step in which the surface of the inorganic particles is treated with an organic acid to form a surface treatment layer having a functional group, and a post-treatment step in which the inorganic particles having the surface treatment layer are treated with a nitrogen-containing post-treatment agent to form a post-treatment layer on the surface of the inorganic particles.

### TECHNICAL FIELD

The present invention relates to a method for producing a resin additive, a resin additive, and an inorganic particle-containing resin composition, and in particular, relates to a method for producing a resin additive with improved miscibility with resins, a method for producing an inorganic particle-containing resin composition, a resin additive, and an inorganic particle-containing resin composition containing the resin additive.

### BACKGROUND ART

Conventionally, attempts have been made to express various functions by incorporating inorganic fillers into resins.

For example, Patent Literature 1 (Japanese Patent Laid-Open No. 2010-189516) proposes resin particles (composite resin particles) containing an inorganic filler (metal oxide or the like) in a uniformly dispersed form and at a high concentration.

In the resin particles (composite resin particles) described in Patent Literature 1, when melt-mixing an inorganic filler (metal oxide particles or the like), a polymer, and an auxiliary agent such as a water-soluble polysaccharide to prepare a dispersion in which resin particles containing the inorganic filler are the dispersed phase and the auxiliary agent is the continuous phase, by selecting, as the inorganic filler, an inorganic filler that has been surface-treated with a hydrophobization treatment agent having a hydrolytically condensable group and a hydrophobic group having no reactivity, the inorganic filler is dispersed in the resin particles at a high concentration and uniformly.

Patent Literature 2 (Japanese Patent Laid-Open No. 2003-171577 proposes a surface-treated inorganic oxide that has excellent affinity (lipophilicity) and dispersibility in organic media such as solvents and resins, as well as water repellency, and also has high heat resistance that prevents yellowing when dispersed in resins under high temperatures using a melting and kneading machine or the like, a production method therefor, and a resin composition using the same.

The production method and resin composition using the same described in Patent Literature 2 are a surface-treated inorganic oxide formed by allowing 3% or more of the hydroxy groups present on the surface of a porous inorganic oxide having hydroxyl groups on the surface thereof to react with an aromatic silicon compound having alkoxyl groups or silanol groups, and a resin composition containing the surface-treated inorganic oxide and a resin.

Also, Patent Literature 3 (Japanese Patent Laid-Open No. 2005-298740) provides inorganic particles that are difficult to agglomerate when incorporated into resins and have a surface treatment layer with good affinity to resins formed thereon, and also proposes a resin composition with high flowability, and good adhesion and durability after curing.

The metal oxide surface-treated particles described in Patent Literature 3 are composed of metal oxide particles and a surface treatment layer. The surface of the metal oxide particles is treated with a silane coupling agent to form the surface treatment layer. The surface treatment layer includes, among a reaction insolubilized layer that is formed by the reaction between all OH groups present on the surface of the metal oxide particles before the treatment and the silane coupling agent and is insoluble in organic solvents, and a solubilized layer that is formed on the surface of the reaction insolubilized layer and is soluble in organic solvents, at least the reaction insolubilized layer. Also, metal oxide powder containing these metal oxide surface-treated particles is incorporated into a resin to form a resin composition.

Furthermore, Patent Literature 4 (Japanese Patent Laid-Open No. 2000-212328) proposes an additive for thermal stabilization of resins.

The additive for heat stabilization of resins described in Patent Literature 4 is a resin additive that is obtained by treating the surface of inorganic particles such as silica and alumina with tannic acid and further subjecting them to a surface treatment with a coupling agent, and prevents a decrease in IZOD impact strength while thermally stabilizing thermoplastic resins.

### CITATION LIST

### Patent Literature

Patent Literature 1: Japanese Patent Laid-Open No. 2010-189516
Patent Literature 2: Japanese Patent Laid-Open No. 2003-171577
Patent Literature 3: Japanese Patent Laid-Open No. 2005-298740
Patent Literature 4: Japanese Patent Laid-Open No. 2000-212328

### SUMMARY OF INVENTION

### Technical Problem

Inorganic particles generally have poor miscibility with resins, which is known to reduce dispersibility upon mixing of inorganic particles into resins. Therefore, it has been investigated to improve dispersibility in resins by subjecting the surface of inorganic particles to surface treatments with various surface treatment agents to hydrophobize it.

As described above, various types of inorganic particles are utilized as fillers (filling agents) in resins, and the dispersibility in resins is controlled by surface treatments with surface treatment agents such as a silane coupling agent. However, in the case where the surface treatment agent is not uniformly fixed to the inorganic particle surface due to agglomeration or other reasons, it becomes difficult to incorporate a large amount of the inorganic particles into resins.

For example, in a surface treatment in which 3-aminopropyltriethoxysilane (APTES, hereinafter also referred to as aminosilane) is fixed to inorganic particles as a surface treatment agent, the reaction system becomes basic due to the influence of the amino group of aminosilane, which causes a significant self-agglomeration reaction of the surface treatment agent, and a structure may be formed on the surface of the inorganic particles where oligomers of the surface treatment agent are adsorbed. In this phenomenon, the amino group of aminosilane is described by analysis as being adsorbed to the inorganic particle surface by a hydrogen bond.

That is, OH groups (silanol: Si—OH) are present on the surface of inorganic particles such as silica particles. Since silanol is hydrophilic, when silica particles are incorporated into a resin, it is difficult for the silica particles to be blended with the resin. When a surface treatment for silica particles is performed using a silane coupling agent, not only does the silane coupling agent adhere to the particle surface, but the silane coupling agent is also self-condensed to form a non-uniform polymer layer. Since the strength of this polymer layer is low, cracks easily occur in the polymer layer after curing. In addition, when a polymer layer is formed on the surface, the viscosity of the resin composition is increased and the flowability is decreased.

In the case where the affinity between the resin and inorganic particles is poor, the viscosity during mixing is high and it is not possible to increase the amount of inorganic particles incorporated. At the same time, as described above, large cracks occur near the boundary between the resin and inorganic particles, entrapping outside gases. Also, since the self-condensation of the silane coupling agent is not uniform, the polymer layer on the inorganic particle surface is peeled off and cracks (gaps) occur at the interface between the inorganic particles and resin when the inorganic particles and resin are mixed with a large torque. Therefore, the cured resin composition has the disadvantage of decreased thermal conductivity and high water absorption.

In particular, in the case where inorganic particles are used as a thermally conductive material and an inorganic particle-containing resin composition is used as a semiconductor sealing agent, insulating sheet, adhesive, or the like, it is necessary to achieve all of the following: high thermal conductivity, temperature resistance, and low water absorption. In recent years, as semiconductor devices have become more sophisticated, heat dissipation of high-temperature components has become more important, requiring resin compositions with extremely high inorganic particle content, as well as inorganic particle-containing resin compositions with extremely low water absorption and high reliability. However, as mentioned above, the affinity between the resin and inorganic particles is not sufficient, making it difficult to provide high thermal conductivity and low water absorption while increasing the content of inorganic particles.

The present invention has been made to solve the above-described disadvantages, and an object thereof is to provide a method for producing a resin additive with which inorganic particles can be incorporated in a large amount into resins and which has good flowability even when having a high inorganic particle content and can improve thermal conductivity and lower water absorption, a resin additive, and an inorganic particle-containing resin composition.

Another object of the present invention is to provide a method for producing a resin additive that can yield a resin additive that is difficult to cause cracks at the interface with resins even after being mixed into the resins and cured, and also difficult to cause agglomeration in the resins, a resin additive, and an inorganic particle-containing resin composition containing the resin additive.

### Solution to Problem

(1)

A method for producing a resin additive according to one aspect comprises: a mixing step of mixing inorganic particles, an organic acid, and a pH adjusting agent to obtain a mixture having a pH of 5 or more and 9 or less; a pre-treatment step of treating the surface of the inorganic particles with the organic acid to form a surface treatment layer having a functional group; and a post-treatment step of treating the inorganic particles having the surface treatment layer formed thereon with a nitrogen-containing post-treatment agent to form a post-treatment layer on the surface of the inorganic particles.

In this case, the method comprises a pre-treatment step of treating the surface of the inorganic particles with the organic acid to form a surface treatment layer having a functional group and a post-treatment step of treating the inorganic particles having the surface treatment layer formed thereon with a nitrogen-containing post-treatment agent to form a post-treatment layer having an amide bond on the surface of the inorganic particles, and therefore, the adsorption (including hydrolysis reaction) to the particle surface by an amino group of the post-treatment agent and the self-condensation reaction of an alkoxy group can be appropriately controlled.

In the post-treatment step, two reactions occur: an amino group of the post-treatment agent is bonded and adsorbed to a carboxyl group (—COOH) on the filler surface, and a polymer is formed by the self-condensation reaction of the post-treatment agent. In this case, the former adsorption reaction takes priority over the latter polymer formation reaction, and thus the post-treatment agent is effectively adsorbed to the inorganic particles while the condensation reaction proceeds in a well-balanced manner. Therefore, the surface treatment layer formed by condensation is firmly and uniformly formed on the surface of the inorganic particles.

In other words, the surface of inorganic particles generally lacks functional groups, and even in the case where hydroxy groups or other groups are present, they are non-uniform, resulting in insufficient miscibility with resins. Therefore, according to the method for producing a resin additive according to one aspect, an organic acid is bonded to the non-uniform hydroxy groups present on the surface of the inorganic particles to uniformize them, which are further bonded to a nitrogen-containing coupling agent or an amino acid. This covers the surface of the inorganic particles with hydroxy groups (coupling agent) or carboxyl groups (amino acid), imparting hydrophilicity and improving the miscibility with resins such as epoxy resins.

The resin additive thus produced has higher affinity with resins, and is difficult to cause cracks at the interface with resins even after curing, and is also difficult to agglomerate in resins. It is also easier to increase the volume fraction of the inorganic particles in resin compositions, which can improve thermal conductivity and decrease water absorption.

Accordingly, inorganic particle-containing resin compositions containing this resin additive can achieve all of the following: high thermal conductivity, crack resistance, and low water absorption, and thus can be used as semiconductor sealing agents with heat dissipation and high reliability.

In particular, aluminum oxide, aluminum nitride, silicon nitride, boron nitride, and magnesium oxide are excellent as thermally conductive materials and can be suitably applied to insulating grease or insulating sheets for power devices and cases for high frequency components. Especially, aluminum nitride is promising as an adhesive or coating material for high vacuum devices for semiconductors when contained in polyimide adhesives.

(2)

The method for producing a resin additive according to a second invention is the method for producing a resin additive according to the invention of one aspect, wherein the organic acid may be a hydroxycarboxylic acid, and the functional group may be a carboxyl group.

This allows a hydroxy group that the organic acid has to be bonded to a OH group on the surface of the inorganic particles, and a carboxyl group that the organic acid has to react with the post-treatment agent, thereby forming a hydrophobic film. Thus, the produced resin additive has higher affinity with resins, and is difficult to cause cracks at the interface with resins even after curing, and is also difficult to agglomerate in resins.

(3)

The method for producing a resin additive according to a third invention is the method for producing a resin additive according to the invention of one aspect or the second invention, wherein the organic acid may be at least one selected from the group consisting of tartaric acid, lactic acid, hydroxybutyric acid, citric acid, glycolic acid, malic acid, and an aromatic hydroxycarboxylic acid.

This allows a hydroxy group that the organic acid has to be bonded to a OH group on the surface of the inorganic particles, and a carboxyl group that the organic acid has to react with the post-treatment agent, thereby forming a hydrophobic film. Thus, the produced resin additive has higher affinity with resins, and is difficult to cause cracks at the interface with resins even after curing, and is also difficult to agglomerate in resins.

(4)

The method for producing a resin additive according to a fourth invention is the method for producing a resin additive according to any of the invention of one aspect to the third invention, wherein the inorganic particles may be of at least one selected from the group consisting of silica, alumina, silicon carbide, magnesium oxide, boron nitride, and aluminum nitride.

By using a variety of types of inorganic particles as the inorganic particles used, resin additives can be produced that have the characteristics of inorganic particles, such as thermal conductivity, dielectric constant, strength, and electrical conductivity.

(5)

The method for producing a resin additive according to a fifth invention is the method for producing a resin additive according to any of the invention of one aspect to the fourth invention, wherein the post-treatment agent may be at least one selected from the group consisting of a silane coupling agent having an amino group or an isocyanate group, and an amino acid having an amino group and a carboxylic acid group.

This makes it possible to form a firm and thin surface treatment layer on the surface by appropriately controlling the adsorption (including hydrolysis reaction) to the particle surface by an amino group and the self-condensation reaction of an alkoxy group.

(6)

The method for producing a resin additive according to a sixth invention is the method for producing a resin additive according to any of the invention of one aspect to the fifth invention, wherein the organic acid may be at least one selected from the group consisting of tartaric acid, lactic acid, hydroxybutyric acid, citric acid, glycolic acid, malic acid, and an aromatic hydroxycarboxylic acid, and the post-treatment agent may be at least one selected from the group consisting of an amino acid, an amino group-containing silane coupling agent, and an isocyanate group-containing silane coupling agent.

This allows the reaction in which an amino group of the post-treatment agent is bonded and adsorbed to a carboxyl group on the filler surface and the reaction in which a polymer is formed by the self-condensation reaction of the post-treatment agent to proceed in a well-balanced manner.

It is also presumed that the balance between reaction A, in which an amino group or the like of the surface treatment agent is bonded to an acid (carboxyl group or the like) on the inorganic particle surface, and reaction B, in which a silanol group (alkoxy group) of the surface treatment agent undergoes self-condensation, is improved, that is, reaction A takes priority while condensation reaction B proceeds, resulting in a uniform surface treatment layer formed by the condensation. As a result, a hydrophobic film is formed uniformly on the surface of the inorganic particles, producing treated particles with high affinity to resins.

In the case where the pH of the mixture is outside the above-described range, the balance between reaction A and condensation reaction B may become poor, and the self-condensation reaction of silanol groups may not be controlled. In order to adjust the pH of the mixture, those easily replaced by a carboxylic acid, such as ammonium carbonate, are preferred.

(7)

The method for producing a resin additive according to a seventh invention is the method for producing a resin additive according to any of the invention of one aspect to the sixth invention, wherein the pH adjusting agent may comprise ammonium carbonate.

By using a carbonate as the pH adjusting agent, it is easily replaced by a carboxylic acid. Furthermore, the use of ammonium as the pH adjusting agent prevents ions such as sodium and potassium from remaining in the system.

This allows the adsorption reaction of the post-treatment agent to the inorganic particles to proceed preferentially, forming a more uniform and better surface treatment layer.

(8)

The method for producing a resin additive according to an eighth invention is the method for producing a resin additive according to any of the invention of one aspect to the seventh invention, wherein the pre-treatment step comprises a heating step of heating the mixture to 70° C. or higher and 95° C. or lower.

This ensures that a functional group (—OH or the like) of the organic acid is bonded to the surface of the inorganic filler in the pre-treatment step. Accordingly, the surface treatment agent can be effectively bonded to the inorganic filler in the post-treatment step.

(9)

The method for producing a resin additive according to a ninth invention is the method for producing a resin additive according to the eighth invention, wherein the pre-treatment step comprises a solution preparing step of adding a solution containing triethanolamine to particles obtained in the heating step to obtain a preparation solution, and removing a solvent from the preparation solution to obtain the inorganic particles.

This allows triethanolamine to be adsorbed to the entire surface of the inorganic particles, and thus allows the post-treatment agent to be preferably fixed to the surface of the inorganic particles in the subsequent post-treatment step.

In particular, in the case where the inorganic particles are of boron nitride or aluminum nitride powder, a hydroxy group or carboxylic acid group and an amino group or amide group may be mixedly present as functional groups on the particle surface, and even when pH adjustment is performed, the post-treatment agent may be preferentially bonded to the hydroxy group or carboxylic acid group. Therefore, by allowing triethanolamine to act on the hydroxy group and carboxylic acid group, the degree of acidity of the particle surface can be adjusted, which allows the post-treatment agent to be preferably fixed to the surface of the inorganic particles.

(10)

A method for producing an inorganic particle-containing resin composition according to another aspect comprises a step of mixing and kneading the resin additive obtained by the method according to any of claims 1 to 9 with a resin.

This yields a resin composition with high flowability that contains inorganic particles having a uniform film formed on the surface. The resin composition thus obtained can achieve all of the following: high thermal conductivity, crack resistance, and low water absorption, and thus can be used as a semiconductor sealing agent or the like with heat dissipation and high reliability.

(11)

A resin additive according to another aspect comprises inorganic particles, a surface treatment layer formed on the surface of the inorganic particles, and a post-treatment layer formed on the surface of the surface treatment layer, wherein the post-treatment layer is formed with a nitrogen atom-containing post-treatment agent.

This makes it possible to form a firm and thin surface treatment layer on the surface of the inorganic particles. The resin additive has higher affinity with resins, and is difficult to cause cracks at the interface with resins even after curing, and is also difficult to agglomerate in resins. Hence, the volume fraction of the inorganic particles in resin compositions can be increased, thereby improving thermal conductivity and decreasing water absorption.

(12)

The resin additive according to a twelfth invention is the resin additive according to the eleventh invention, wherein the surface treatment layer may comprise at least one organic acid selected from the group consisting of tartaric acid, lactic acid, hydroxybutyric acid, citric acid, glycolic acid, malic acid, and an aromatic hydroxycarboxylic acid, and the post-treatment layer may comprise at least one post-treatment agent selected from the group consisting of an amino acid, an amino group-containing silane coupling agent, and an isocyanate group-containing silane coupling agent.

This makes it possible to appropriately control the adsorption (including hydrolysis reaction) to the particle surface by an amino group of the post-treatment agent and the self-condensation reaction of an alkoxy group, and to form a firm and thin surface treatment layer on the surface of the inorganic particles.

Thus, the produced resin additive has higher affinity with resins, and is difficult to cause cracks at the interface with resins even after curing, and is also difficult to agglomerate in resins. Hence, the volume fraction of the inorganic particles in resin compositions can be increased, thereby improving thermal conductivity and decreasing water absorption.

(13)

An inorganic particle-containing resin composition according to another aspect comprises the resin additive according to claim 11 or 12 and a resin. As the resin, for example, thermoplastic resins and thermosetting resins such as epoxy resins can be used.

This yields a resin composition with high flowability that contains inorganic particles having a uniform film formed on the surface. The resin composition thus obtained can achieve all of the following: high thermal conductivity, crack resistance, and low water absorption, and thus can be used as a semiconductor sealing agent with heat dissipation and high reliability.

In particular, aluminum oxide, aluminum nitride, silicon nitride, boron nitride, and magnesium oxide are excellent as thermally conductive materials and can be suitably applied to insulating grease or insulating sheets for power devices and cases for high frequency components. Especially, aluminum nitride is promising as an adhesive or coating material for high vacuum devices for semiconductors when contained in polyimide adhesives.

### BRIEF DESCRIPTION OF DRAWINGS

FIG. 1 is a diagram showing the relationship between filling rate and viscosity in the case where the particles obtained in Examples 9 and 10 were mixed into an epoxy resin.

FIG. 2 is a diagram showing the thermal conductivity of the cured product obtained by thermally curing the particles obtained in Examples 9 and 10.

FIG. 3 is the diffuse FTIR spectra of the treated particles obtained in Example 9 and Comparative Examples 9 and 10.

### DESCRIPTION OF EMBODIMENTS

Hereinafter, the method for producing a resin additive of the present embodiment will be described in detail.

The method for producing a resin additive of the present invention comprises a pre-treatment step of treating the surface of inorganic particles with an organic acid to form a surface treatment layer having a functional group such as carboxyl group and a post-treatment step of treating the inorganic particles having the surface treatment layer formed thereon with a nitrogen-containing post-treatment agent to form a post-treatment layer having a bond group such as amide bond on the surface of the inorganic particles.

In the case where a hydroxycarboxylic acid is used as the organic acid and a silane coupling agent containing a nitrogen atom such as amino group is used as the post-treatment agent, an example of the reaction mechanism of the method for producing a resin additive of the present invention is as follows.
(1) By mixing inorganic particles and an organic acid and raising the temperature to 90° C., a functional group [—OH or the like] of the organic acid is bonded to the inorganic particle surface to form a carboxyl group on the surface of the inorganic particles.
(2) Next, when a surface treatment agent is added, an amino group or the like of the surface treatment agent is bonded to a carboxyl group [—COOH] or the like on the inorganic particle surface to form an amide bond.
(3) As the concentration of the surface treatment agent is further increased, a polymer is formed by the self-condensation reaction of silanol groups to coat the inorganic particle surface.
(4) The coated inorganic particles have high miscibility with resins such as epoxy resins, and can be filled at a high density, resulting in higher thermal conductivity and decreased water absorption.

In particular, in order to achieve an appropriate balance between the above-described reaction (2) and reaction (3), it is preferable to set the reaction system to a pH of 5 to 9. By setting the pH in this range, it is presumed that the reaction (2) takes priority while the condensation reaction (3) proceeds, resulting in a uniform surface treatment layer formed by the condensation.

In other words, if the condensation reaction (3) proceeds preferentially, condensation of the surface treatment agent itself takes priority and agglomerates are formed separately from the inorganic particles, making it difficult to uniformly coat the inorganic particle surface. In contrast, according to the method for producing a resin additive of the present invention, the bonding reaction (2) takes priority while the condensation reaction (3) proceeds, resulting in the formation of a uniform surface treatment layer at a high density on the surface of the inorganic particles. This allows the treated inorganic particles obtained by the present method to have higher miscibility with resins such as epoxy resins, suppressing an increase in resin viscosity and enabling high-density filling, which results in higher thermal conductivity. In addition, the high miscibility between the particles and resins prevents occurrence of cracks or other defects even after the resins are cured, making it possible to produce resin molded products with excellent mechanical properties, low water absorption, and excellent stability.

Note that the silane coupling agent used as the post-additive can be used in place of an amino acid having an amino group and a carboxylic acid group.

### (Inorganic Particles)

There are no particular limitations on the inorganic particles used in the present invention, and any inorganic particles that can be effectively used for the purpose of the present invention may be used.

Examples thereof include silica, alumina, silicon carbide, magnesium oxide, boron nitride, and aluminum nitride. Furthermore, talc, clay, mica, aluminum silicate, kaolinite, and others can also be used.

In the case where these inorganic particles are used as an additive for resins (binders) of semiconductor sealing agents, aluminum nitride (AlN), magnesium oxide (MgO), boron nitride (BN), silicon carbide (SiC), aluminum oxide (Al₂O₃), silicon nitride (Si₄N₄), silicon (Si), silicon oxide (SiO₂), and others can be used in terms of improving thermal conductivity.

In terms of increasing thermal conductivity when added to resins, aluminum nitride (AlN), magnesium oxide (MgO), boron nitride (BN), silicon carbide (Sic), and aluminum oxide (Al₂O₃) are preferred, and among these, aluminum nitride (AlN) and silicon carbide (SiC) are still more preferred.

Also, in terms of keeping water absorption low when added to resins, aluminum nitride (AlN), magnesium oxide (MgO), silicon carbide (SiC), silicon nitride (Si₄N₄), and silicon oxide (SiO₂) are preferred, and among these, silicon nitride (Si₄N₄) and silicon oxide (SiO₂) are still more preferred.

There are no particular limitations on the particle size and shape of the inorganic particles, which are selected for use as appropriate depending on their type and purpose of use.

In the case where these inorganic particles are used as an additive for resins (binders) of semiconductor sealing agents, the core particle diameter of the inorganic particles is preferably 2 μm or more and 50 μm or less, more preferably 5 μm or more and 20 μm or less, and still more preferably 6 μm or more and 15 μm or less.

By setting the particle size in the above-described range, the mechanical characteristics can be maintained while increasing the thermal conductivity of resin molded products. Various combinations of particle diameters are possible; for example, combining particles with a large particle size with sub-micron particles can increase the number of contact points between the inorganic particles themselves. In this case as well, it is preferable for the inorganic particles to be uniformly filled in resins from the viewpoint of percolation, which can improve the thermal conductivity.

Note that the measurement of particle size in the present embodiment was performed using Microtrac HRA9320-X100 manufactured by MicrotracBEL Corp., in accordance with ISO 13320.

The material, particle size, and shape of these inorganic particles can be selected as appropriate depending on the purpose as the resin additive to be used, and a plurality of materials, particle sizes, and shapes can be combined for use.

For example, aluminum oxide, aluminum nitride, silicon nitride, boron nitride, and magnesium oxide are excellent as thermally conductive materials and can be suitably applied to insulating grease or insulating sheets for power devices and cases for high frequency components. Especially, aluminum nitride is promising as an adhesive or coating material for high vacuum devices for semiconductors when contained in polyimide adhesives.

### (Organic Acid)

The organic acid used in the present invention is preferred the functional group may be a carboxyl group and typically a hydroxycarboxylic acid.

Since the organic acid has a hydroxyl group, it can be bonded to a functional group (typically hydroxy group [—OH]) on the inorganic particle surface, and since the organic acid has a carboxyl group as a functional group, it can preferentially advance the reaction of the surface treatment described later, while making the inorganic particles acidic.

Also, inorganic particles often have a basic surface when immersed in pure water. For example, in the case of aluminum oxide, the isoelectric point of zeta potential is in the range of 5 to 9, and the particle surface shifts toward the basic side as the immersion time progresses. Therefore, by bonding an organic acid to the inorganic particles to make the surface of the inorganic particles acidic, an amino group of the post-treatment agent is easily adsorbed to the inorganic particle surface, and furthermore, the weak acidity near the particle surface promotes the self-condensation reaction of silanol groups.

As the organic acid, aliphatic hydroxycarboxylic acids and aromatic hydroxycarboxylic acids can be used. Specifically, as the organic acid, at least one selected from the group consisting of tartaric acid, lactic acid, salicylic acid, gallic acid, hydroxybutyric acid, citric acid, glycolic acid, malic acid, and aromatic hydroxycarboxylic acids can be used.

Among these, tartaric acid, lactic acid, salicylic acid, gallic acid, and hydroxybutyric acid are preferred since they are easily dissolved, especially in water, and the pH can be easily controlled.

Also, in terms of preferable formation of the surface treatment layer and excellent high thermal conductivity and low water absorption when added to resins, tartaric acid and lactic acid are more preferred.

However, the organic acid selected here can be selected as appropriate depending on the type of inorganic particles, the type of post-treatment agent, and the purpose as the resin additive to be used. Also, if necessary, a plurality of organic acids can be combined for use as appropriate.

In this case, the organic acid is preferably adjusted to a pH of 5 or more and 9 or less, and more preferably to a pH of 5 or more and 7 or less, using a pH adjusting agent. This allows the adsorption reaction of the post-treatment agent to the inorganic particles to proceed preferentially, forming a uniform surface treatment layer.

As the pH adjusting agent, carbonates can be used, and in particular, it is preferable to use ammonium carbonate. By using a carboxylic acid salt, it is easily replaced by a carbonate, and the use of ammonium prevents ions such as sodium and potassium from remaining in the system.

### (Heating Step)

The mixture in which the organic acid, adjusted with the pH adjusting agent, and the inorganic particles have been mixed can be acidified near the surface of the inorganic particles by heating to a high temperature for a predetermined time. In this case, the heating temperature is preferably 70° C. or higher and 95° C. or lower, more preferably 85° C. or higher and 93° C. or lower, and the heating time is preferably 1 hour or longer and 10 hours or shorter.

This allows an amino group of the post-treatment agent to be easily adsorbed to the inorganic particle surface, and furthermore, the weak acidity near the particle surface promotes the self-condensation reaction of silanol groups.

### (Solution Preparing Step)

A solution containing triethanolamine is added to the particles obtained in the heating step to obtain a preparation solution. Furthermore, the obtained preparation solution is filtered, the solvent is removed, and the inorganic particles are obtained by drying.

In this manner, triethanolamine can be adsorbed to the entire surface of the inorganic particles. This allows the post-treatment agent having an amino group to be preferably fixed to the surface of the inorganic particles in the subsequent step.

In particular, in the case where the inorganic particles are of powder having a nitride such as boron nitride or aluminum nitride, although the particle surface has few functional groups, it has amino groups as well as hydroxy groups, and in the case where there are many strongly acidic functional groups, it is preferable to stabilize the pH. By allowing triethanolamine to act on the particle surface, the degree of acidity can be adjusted, which allows the post-treatment agent to be preferably fixed to the surface of the inorganic particles.

Note that in the case where the inorganic particles are other than boron nitride and aluminum nitride, triethanolamine is not essential. However, even in that case, when there are strong acid sites on the particle surface, self-condensation is likely to occur locally, and therefore, triethanolamine may be added for the purpose of eliminating the strong acid sites.

### (Post-Treatment Agent)

As the post-treatment agent used in the present invention, at least one selected from the group consisting of a silane coupling agent having an amino group or an isocyanate group, an amino acid having an amino group and a carboxylic acid group, and a nitrogen atom-containing silane coupling agent can be used. (1) In the case where the post-treatment agent is a silane coupling agent having an amino group

Since the post-treatment agent has an amino group, it is adsorbed to the surface of the inorganic particles by the post-treatment, and furthermore, since it has a hydroxyl group (alkoxy group), a self-condensation reaction occurs due to the weak acidity near the particle surface. Accordingly, a polymer film by the post-treatment agent is formed on the surface of the inorganic particles, and therefore, a uniform organic layer is formed at a high density on the surface of the inorganic particles.

The inorganic particles having such an organic layer formed thereon have higher miscibility with resins such as epoxy resins, suppressing an increase in resin viscosity and enabling high-density filling, which results in higher thermal conductivity. In addition, cracks or other defects are unlikely to occur even after the resins are cured, making it possible to produce resin molded products with excellent mechanical properties, low water absorption, and excellent stability.

As the post-treatment agent, in addition to the amino group-containing silane coupling agent, an amino acid, an isocyanate group-containing silane coupling agent, and others can be used.

Examples of the amino acid include glycine, alanine, valine, leucine, isoleucine, lysine, serine, threonine, phenylalanine, aspartic acid, glutamic acid, methionine, arginine, tryptophan, histidine, proline, oxyproline and cysteine.

The amino group-containing silane coupling agent can be, for example, 2-aminoethyltrimethoxysilane, 3-aminopropyltrimethoxysilane, 3-aminopropyltriethoxysilane, 2-[N-(2-aminoethyl)amino]ethyltrimethoxysilane, 3-[N-(2-aminoethyl)amino]propyltrimethoxysilane, 3-(2-aminoethyl)amino]propyltriethoxysilane, N-phenyl-3-aminopropyltrimethoxysilane, or the like.

The isocyanate group-containing silane coupling agent can be 2-isocyanatoethyltrimethoxysilane, 2-isocyanatoethyltriethoxysilane, 3-isocyanatopropyltrimethoxysilane, 3-isocyanatopropyltriethoxysilane, or the like.

In this case, these post-treatment agents may be used singly or in combinations of two or more thereof.

Among the above, as the amino acid, it is preferable to use alanine, glycine, cysteine, aspartic acid, or the like. Also, as the amino group-containing silane coupling agent, it is preferable to use 3-aminopropyltriethoxysilane, N-phenyl-3-aminopropyltrimethoxysilane, N-2-(aminoethyl)-3-aminopropylmethyldimethoxysilane, or the like.

As the isocyanate group-containing silane coupling agent, it is preferable to use 3-isocyanatopropyltriethoxysilane or the like.
(2) In the case where the post-treatment agent is an amino acid, as well as in the case where the post-treatment agent is an isocyanate group-containing silane coupling agent, similarly to the case where the post-treatment agent is an amino group-containing silane coupling agent, since the post-treatment agent has an amino group or an isocyanate group, it is adsorbed to the surface of the inorganic particles by the post-treatment, and furthermore, since it has a hydroxyl group, a self-condensation reaction occurs due to the weak acidity near the particle surface. Accordingly, a polymer film by the post-treatment agent is formed on the surface of the inorganic particles, and therefore, a uniform organic layer is formed at a high density on the surface of the inorganic particles.

The inorganic particles having such an organic layer formed thereon have higher miscibility with resins such as epoxy resins, suppressing an increase in resin viscosity and enabling high-density filling, which results in higher thermal conductivity. In addition, cracks or other defects are unlikely to occur even after the resins are cured, making it possible to produce resin molded products with excellent mechanical properties, low water absorption, and excellent stability.

Although the proportion of the post-treatment agent incorporated into the inorganic particles can be selected depending on the types of the inorganic particles and post-treatment agent, for example, it may be 0.1% by weight or more and 15% by weight or less (for example, 0.3% by weight or more and 12% by weight or less), preferably 0.5% by weight or more and 10% by weight or less (for example, 0.7% by weight or more and 8% by weight or less), and still more preferably about 1% by weight or more and 7% by weight or less (for example, 1% by weight or more and 5% by weight or less).

### (Resin Additive)

The resin additive of the present invention comprises inorganic particles, a surface treatment layer formed on the surface of the inorganic particles, and a post-treatment layer formed on the surface of the surface treatment layer, and the post-treatment layer is formed with a nitrogen atom-containing post-treatment agent.

As the inorganic particles, the inorganic particles described above can be used, and as the post-treatment agent, the post-treatment agent described above can be used.

### (Inorganic Particle-Containing Resin Composition)

The inorganic particle-containing resin composition of the present invention comprises the resin additive described above and a resin.

Examples of the resin used in the resin composition include a thermosetting resin, a thermoplastic resin, an elastomer, and a rubber.

Examples of the thermosetting resin include an epoxy resin, a silicon resin, a phenol resin, a melamine resin, a urea resin, and an unsaturated polyester resin.

Also, examples of the thermoplastic resin include a fluororesin, a polyimide, a polyamide resin (such as polyamideimide and polyetherimide), a polyester (such as polybutylene terephthalate, polyethylene terephthalate, and fully aromatic polyester), a polysulfone resin, and a polycarbonate.

Examples of the elastomer and rubber include a styrene-butadiene rubber, an ethylene-propylene rubber, a polybutadiene rubber, a polyisoprene rubber, a nitrile rubber, an epichlorohydrin rubber, a neoprene rubber, a butyl rubber, a polysulfide, and a urethane rubber.

Among these, from the viewpoint of processability, a thermosetting resin is preferably used. Specifically, one or more selected from an epoxy resin, a phenol resin, a polyurethane, a polyimide, and an unsaturated polyester are preferably exemplified.

In the case where the inorganic particle-containing resin composition is used as a semiconductor sealing agent, as the resin (binder), it is preferable to use an epoxy resin, a silicone resin, a urethane resin, an acrylic resin, or other resins. Among these, from the viewpoint of containing the inorganic particles, it is preferable to use a silicone resin or an epoxy resin, and it is more preferable to use an epoxy resin.

The inorganic particle-containing resin composition in which aluminum oxide, aluminum nitride, silicon nitride, boron nitride, or magnesium oxide is used as the inorganic particles can be suitably used as a thermally conductive material, or can be used for insulating grease or insulating sheets for power devices and cases for high frequency components. In particular, the inorganic particle-containing resin composition containing aluminum nitride can be suitably used as an adhesive or coating material for high vacuum devices for semiconductors when contained in polyimide adhesives.

Note that these may be used singly or may be used in a mixture of two or more thereof.

The resin additive and the resin can be mixed in an appropriate weight ratio depending on the purpose and required physical properties.

The resin additive and the resin may be kneaded using various mixers, dispersers, and kneaders. For example, the mixing can be performed using a commonly used kneader (for example, single screw or twin screw extruder, kneader, calender roll, Banbury mixer, blender, or the like).

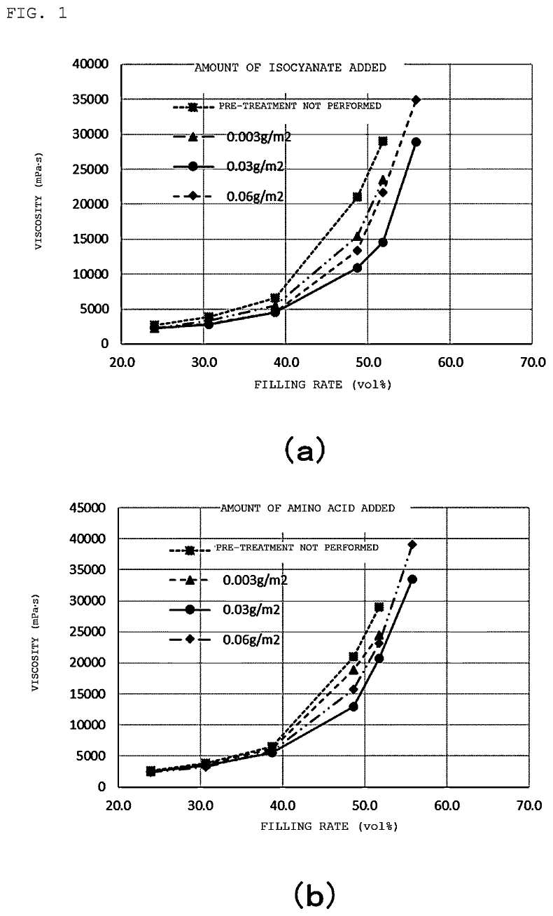

The production process and measurement methods for each of the Examples and Comparative Examples will be described in detail below, and the measurement results are shown in Tables 1 to 2 and FIGS. 1 to 3.

Hereinafter, Examples of the present invention will be described, but the present invention is not limited to the following Examples.

### Example 1

After pre-treating aluminum nitride AlN particles as the inorganic particles, ammonium carbonate was used as the pH adjusting agent, tartaric acid as the organic acid, and 3-aminopropyltriethoxysilane as the post-treatment agent to obtain treated aluminum nitride particles (resin additive). Furthermore, the obtained treated aluminum nitride particles were added to an epoxy resin, and a resin cured product was obtained.

### <Pre-Treatment Step>

Aluminum nitride particles with a core particle size of 30 μm were provided, and tartaric acid was provided as the organic acid. Ammonium carbonate and tartaric acid were added to pure water such that the content of tartaric acid was 0.05 parts by weight, the content of ammonium carbonate was 0.026 parts by weight, and pure water was 100 parts by weight with respect to 100 parts by weight of aluminum nitride particles, thus preparing a solution with a pH of 5.5.

Next, aluminum nitride particles were added to the solution, which was heated and stirred to 90° C. for 6 hours while stirring using the Henschel mixer (FM-20C/I) manufactured by Nippon Coke & Engineering Co., Ltd. to obtain a dispersion. (mixing step)

Next, the dispersion was returned to ordinary temperature (25° C.), filtered to remove the solution, and the resulting aluminum nitride particles were put into a 0.05 (W/V) % triethanolamine solution and stirred for 3 minutes using the Henschel mixer.

Triethanolamine was adsorbed to the aluminum nitride particles in this manner, the preparation solution was filtered to remove the solution, and furthermore, after washing the obtained aluminum nitride particles with pure water, they were dried at 120° C. for 60 minutes using the Henschel mixer. (solution preparing step)

In the present Examples, this solution preparing step was performed only in the case where the inorganic particles were aluminum nitride, boron nitride, or alumina.

### <Post-Treatment Step>

The aluminum nitride particles thus pre-treated were placed in the Henschel mixer, and 3-aminopropyltriethoxysilane (1 W/V %: KBE-903 manufactured by Shin-Etsu Chemical Co., Ltd.) was gradually added as the post-treatment agent with stirring, and the self-condensation reaction was allowed to proceed by continuous stirring at 100 to 120° C. for about 1 hour to obtain treated particles as the resin additive.

For the obtained treated particles, the volume fraction (%), thermal conductivity (W/mk), and water absorption (%) were measured and are shown in Table 1.

### OTHER EXAMPLES

Hereinafter, other Examples of the present invention will be described.

Note that the solution preparing step with triethanolamine was performed only in the case of aluminum nitride, boron nitride, and alumina, and no solution preparing step was performed in the case where inorganic particles other than the above were used.

### Example 2

Treated particles as the resin additive were obtained in the same manner as in Example 1, except that 0.07 parts by weight of lactic acid (manufactured by Fujifilm Wako Pure Chemical Corporation) as the organic acid and 0.025 parts by weight of ammonium carbonate were used to prepare a solution with a pH of 5.5 (+0.5).

Also, the treated particles were obtained in the same manner as in Example 1, except that 1 part by weight of 3-isocyanatopropyltriethoxysilane (KBE-9007N manufactured by Shin-Etsu Chemical Co., Ltd.) was used as the post-treatment agent. For the obtained treated particles, the measurement results are shown in Table 1.

Note that the contents of lactic acid and ammonium carbonate, as well as the pH of the solution, are the same as in Example 1.

### Comparative Example 1

Treated particles were obtained in the same manner as in Example 1, except that 0.22 parts by weight of 4% hydrochloric acid (manufactured by Fujifilm Wako Pure Chemical Corporation) was used instead of the organic acid. For the obtained treated particles, the measurement results are shown in Table 1.

### Comparative Example 2

Treated particles were obtained in the same manner as in Example 1, except that the organic acid and pH adjusting agent were not used (only pure water was used). For the obtained treated particles, the measurement results are shown in Table 1.

### Example 3

Treated particles were obtained in the same manner as in Example 1, except that 100 parts by weight of magnesium oxide MgO with a core particle size of 10 μm was used as the inorganic particles, 0.05 parts by weight of tartaric acid was used as the organic acid, and 1 part by weight of alanine was used as the post-treatment agent. For the obtained treated particles, the measurement results are shown in Table 1.

### Example 4

Treated particles were obtained in the same manner as in Example 3, except that 0.07 parts by weight of lactic acid (manufactured by Fujifilm Wako Pure Chemical Corporation) was used as the organic acid and 1 part by weight of 3-aminopropyltriethoxysilane was used as the post-treatment agent. For the obtained treated particles, the measurement results are shown in Table 1.

### Comparative Example 3

Treated particles were obtained in the same manner as in Example 3, except that the organic acid and pH adjusting agent were not used (only pure water was used). For the obtained treated particles, the measurement results are shown in Table 1.

### Comparative Example 4

Treated particles were obtained in the same manner as in Example 3, except that 0.22 parts by weight of 4% hydrochloric acid (manufactured by Fujifilm Wako Pure Chemical Corporation) was used instead of the organic acid. For the obtained treated particles, the measurement results are shown in Table 1.

### Example 5

Treated particles were obtained in the same manner as in Example 1, except that 100 parts by weight of boron nitride BN with a core particle size of 5 μm was used as the inorganic particles and 1 part by weight of glycine (manufactured by Fujifilm Wako Pure Chemical Corporation) was used as the post-treatment agent. For the obtained treated particles, the measurement results are shown in Table 1.

### Example 6

Treated particles were obtained in the same manner as in Example 5, except that 0.07 parts by weight of lactic acid (manufactured by Fujifilm Wako Pure Chemical Corporation) was used as the organic acid. For the obtained treated particles, the measurement results are shown in Table 1.

### Comparative Example 5

Treated particles were obtained in the same manner as in Example 5, except that the organic acid and pH adjusting agent were not used (only pure water was used). For the obtained treated particles, the measurement results are shown in Table 1.

### Comparative Example 6

Treated particles were obtained in the same manner as in Example 5, except that 0.22 parts by weight of 4% hydrochloric acid (manufactured by Fujifilm Wako Pure Chemical Corporation) was used instead of the organic acid. For the obtained treated particles, the measurement results are shown in Table 1.

### Example 7

Treated particles were obtained in the same manner as in Example 1, except that 100 parts by weight of silicon carbide SiC with a core particle size of 10 μm was used as the inorganic particles and 1 part by weight of cysteine (manufactured by Fujifilm Wako Pure Chemical Corporation) was used as the post-treatment agent. For the obtained treated particles, the measurement results are shown in Table 1.

### Example 8

Treated particles were obtained in the same manner as in Example 7, except that 0.07 parts by weight of lactic acid (Fujifilm Wako Pure Chemical Corporation) was used as the organic acid and 1 part by weight of N-phenyl-3-aminopropyltrimethoxysilane (KBM-573 manufactured by Shin-Etsu Chemical Co., Ltd.) was used as the post-treatment agent. For the obtained treated particles, the measurement results are shown in Table 1.

### Comparative Example 7

Treated particles were obtained in the same manner as in Example 7, except that the organic acid and pH adjusting agent were not used (only pure water was used). For the obtained treated particles, the measurement results are shown in Table 1.

### Comparative Example 8

Treated particles were obtained in the same manner as in Example 7, except that 0.22 parts by weight of 4% hydrochloric acid (manufactured by Fujifilm Wako Pure Chemical Corporation) was used instead of the organic acid. For the obtained treated particles, the measurement results are shown in Table 1.

### Example 9

Treated particles were obtained in the same manner as in Example 1, except that 100 parts by weight of aluminum oxide Al₂O₃ with a core particle size of 10 μm was used as the inorganic particles and 1 part by weight of alanine (manufactured by Fujifilm Wako Pure Chemical Corporation) was used as the post-treatment agent. For the obtained treated particles, the measurement results are shown in Table 1.

### Example 10

Treated particles were obtained in the same manner as in Example 9, except that 0.05 parts by weight of salicylic acid (manufactured by Fujifilm Wako Pure Chemical Corporation) was used as the organic acid and 1 part by weight of 3-isocyanatopropyltriethoxysilane (KBE-9007N manufactured by Shin-Etsu Chemical Co., Ltd.) was used as the post-treatment agent. For the obtained treated particles, the measurement results are shown in Table 1.

### Comparative Example 9

Treated particles were obtained in the same manner as in Example 9, except that the organic acid and pH adjusting agent were not used (only pure water was used). For the obtained treated particles, the measurement results are shown in Table 1.

### Comparative Example 10

Treated particles were obtained in the same manner as in Example 9, except that 0.22 parts by weight of 4% hydrochloric acid (manufactured by Fujifilm Wako Pure Chemical Corporation) was used instead of the organic acid. For the obtained treated particles, the measurement results are shown in Table 1.

### Example 11

Treated particles were obtained in the same manner as in Example 1, except that 100 parts by weight of silicon nitride Si₃N₄ with a core particle size of 10 μm was used as the inorganic particles and 1 part by weight of aspartic acid (manufactured by Fujifilm Wako Pure Chemical Corporation) was used as the post-treatment agent. For the obtained treated particles, the measurement results are shown in Table 2.

### Example 12

Treated particles were obtained in the same manner as in Example 11, except that 0.05 parts by weight of gallic acid monohydrate (manufactured by Fuji Chemical Co., Ltd.) as the organic acid and 0.01 parts by weight of ammonium carbonate were used. For the obtained treated particles, the measurement results are shown in Table 2.

### Comparative Example 11

Treated particles were obtained in the same manner as in Example 11, except that the organic acid and pH adjusting agent were not used (only pure water was used). For the obtained treated particles, the measurement results are shown in Table 2.

### Comparative Example 12

Treated particles were obtained in the same manner as in Example 11, except that 0.22 parts by weight of 4% hydrochloric acid (manufactured by Fujifilm Wako Pure Chemical Corporation) was used as the organic acid. For the obtained treated particles, the measurement results are shown in Table 2.

### Example 13

Treated particles were obtained in the same manner as in Example 1, except that 100 parts by weight of silicon Si with a core particle size of 10 μm was used as the inorganic particles and 1 part by weight of N-2-(aminoethyl)-3-aminopropylmethyldimethoxysilane (KBM-602 manufactured by Shin-Etsu Chemical Co., Ltd.) was used as the post-treatment agent. For the obtained treated particles, the measurement results are shown in Table 2.

### Example 14

Treated particles were obtained in the same manner as in Example 13, except that 0.05 parts by weight of hydroxybutyric acid (manufactured by Fujifilm Wako Pure Chemical Corporation) as the organic acid and 0.01 parts by weight of ammonium carbonate were used. For the obtained treated particles, the measurement results are shown in Table 2.

### Comparative Example 13

Treated particles were obtained in the same manner as in Example 13, except that the organic acid and pH adjusting agent were not used (only pure water was used). For the obtained treated particles, the measurement results are shown in Table 2.

### Comparative Example 14

Treated particles were obtained in the same manner as in Example 13, except that 0.22 parts by weight of 4% hydrochloric acid (manufactured by Fujifilm Wako Pure Chemical Corporation) was used instead of the organic acid. For the obtained treated particles, the measurement results are shown in Table 2.

### Example 15

Treated particles were obtained in the same manner as in Example 1, except that 100 parts by weight of silicon oxide SiO₂ with a core particle size of 10 μm was used as the inorganic particles. For the obtained treated particles, the measurement results are shown in Table 2.

### Example 16

Treated particles were obtained in the same manner as in Example 15, except that 0.07 parts by weight of lactic acid (manufactured by Fujifilm Wako Pure Chemical Corporation) was used as the organic acid. For the obtained treated particles, the measurement results are shown in Table 2.

### Comparative Example 15

Treated particles were obtained in the same manner as in Example 15, except that the organic acid and pH adjusting agent were not used (only pure water was used). For the obtained treated particles, the measurement results are shown in Table 2.

### Comparative Example 16

Treated particles were obtained in the same manner as in Example 15, except that 0.22 parts by weight of 4% hydrochloric acid (manufactured by Fujifilm Wako Pure Chemical Corporation) was used instead of the organic acid. For the obtained treated particles, the measurement results are shown in Table 2.

### <Measurement of Resin Additive and Inorganic Particle-Containing Resin Composition>

For the treated particles (resin additives) obtained in each of the Examples and Comparative Examples, the viscosity of the inorganic particle-containing resin composition, and the thermal conductivity (W/mk), water absorption (%), and volume fraction (%) of the cured product of the inorganic particle-containing resin composition were measured. The respective measurement methods are as follows.

### (Viscosity Measurement)

The treated particles (resin additive) were dispersed in an epoxy resin (JER-807 manufactured by Mitsubishi Chemical Corporation), and the viscosity of the inorganic particle-containing resin composition was measured using a viscometer (Visco Basic Plus manufactured by Fungilab S.A.).

### (Thermal Conductivity Measurement)

The thermal conductivity was evaluated by the laser flash method. The measurement equipment and measurement conditions used were as follows.

Measurement equipment: TC-7000 manufactured by ULVAC-RIKO, Inc.
Method for determining thermal conductivity: half time method
Measurement temperature: Room temperature 25° C.

Specifically, the treated particles obtained in Examples and Comparative Examples were dispersed (20 to 60 vol %) in an epoxy resin (JER-807 made by Mitsubishi Chemical Corporation) and cured to prepare test specimens. Then, the test specimens were cut out into disk-shaped samples with a diameter of 10 mm and a thickness of about 1 mm. After forming a carbon film on the surface of the samples using carbon spray, measurement was performed using the measurement device TC-7000. For the thermal conductivity, the thermal diffusivity was determined by the laser flash method, while the specific heat was measured by attaching a thermocouple to the samples, and their integrated value was used as the thermal conductivity.

### (Water Absorption Measurement)

In order to confirm the kneading condition of the molded product, in which the resin and particles had been kneaded, the water absorption was measured by an autoclave test (120° C., 12 hours). When the miscibility between the resin and particles is excellent, the viscosity of the resin is low, and they are smoothly and completely mixed, then inorganic particle-containing resin compositions with few cracks and pores can be made.

The treated particles (resin additive) obtained in Examples and Comparative Examples were dispersed ( . . . % by weight) in an epoxy resin (JER-807 made by Mitsubishi Chemical Corporation) and cured to prepare test specimens. For these test specimens, the water absorption was measured by an autoclave test (120° C., 24 hours).

Specifically, cylindrical test specimens with a diameter of 10 mm and a thickness of 10 mm were fabricated, and the test specimens were placed in a Teflon® autoclave container while immersed in water, and pressurized at 2 atm for 24 hours while heated to 120° C. to fabricate water absorption specimens. The increase in weight with respect to the initial weight was then used as the amount of water absorption.

### (Filling Rate and Volume Fraction)

The treated particles obtained in Examples and Comparative Examples were filled into an epoxy resin (JER-807 manufactured by Mitsubishi Chemical Corporation) to produce inorganic particle-containing resin compositions.

The filling rate of the treated particles in the resin composition was varied, and the relationship between the filling rate of the treated particles and the viscosity of the inorganic particle-containing resin composition was measured. The viscosity was measured using a B-type viscometer (Visco Basic Plus manufactured by Fungilab S.A.) and is shown in Tables 1 and 2.

<Measurement of Resin Viscosity with Respect to Filling Rate>

When the self-condensation layer is too thick, steric hindrance occurs and uniform particle coating becomes difficult, thus decreasing the effect of the surface treatment agent.

In order to confirm the effect of the surface treatment agent, the particles were dispersed in an epoxy resin (JER-807 manufactured by Mitsubishi Chemical Corporation), and the effect and fixation state of the surface treatment were confirmed by measuring the change in viscosity.

The resin additives obtained in Example 10 (inorganic particles: aluminum oxide Al₂O₃, isocyanate: 3-isocyanatopropyltriethoxysilane) and Example 9 (inorganic particles: aluminum oxide Al₂O₃, amino acid: alanine) were filled into a mixture of the epoxy resin and a curing agent (jER-113 manufactured by Mitsubishi Chemical Corporation) to produce inorganic particle-containing resin compositions. The relationship between the filling rate of the resin additives and the viscosity of the inorganic particle-containing resin compositions at that time was measured. Note that the weight ratio between the epoxy resin and curing agent was 1:1, and the resin viscosity was measured at room temperature (25° C.).

The obtained results are shown in FIG. 1. The viscosity was measured using a B-type viscometer (Visco Basic Plus manufactured by Fungilab S.A.), with the filling amount of the resin additive to the epoxy resin on the horizontal axis and the viscosity of the inorganic particle-containing resin composition on the vertical axis.

FIG. 1(a) shows Example 10 with varying amounts of the post-treatment agent (3-isocyanatopropyltriethoxysilane) added, and FIG. 1(b) shows Example 9 with varying amounts of the post-treatment agent (alanine) added.

In this case, the results showed that the amount of isocyanate added to the treated particles was preferably 0.003 g/m² or more and 0.06 g/m² or less, and more preferably 0.01 g/m² or more and 0.03 g/m² or less.

<Measurement of Thermal Conductivity with Respect to Filling Rate>

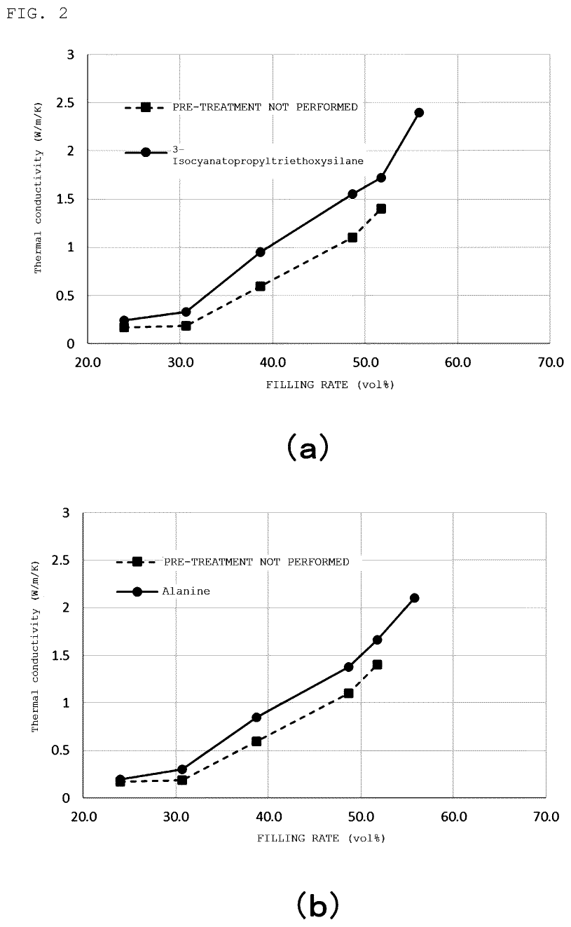

Furthermore, inorganic particle-containing resin compositions obtained from Example 10 (inorganic particles: aluminum oxide Al₂O₃, isocyanate: 3-isocyanatopropyltriethoxysilane) and Example 9 (inorganic particles: aluminum oxide Al₂O₃, amino acid: alanine) and an epoxy resin were thermally cured, and the thermal conductivity of the obtained cured products was measured. The measurement results are shown in FIGS. 2(a) and (b), respectively.

The thermal conductivity was evaluated by the laser flash method. The measurement equipment and measurement conditions used were as follows.

Measurement equipment: TC-7000 manufactured by ULVAC-RIKO, Inc.
Method for determining thermal conductivity: half time method
Measurement temperature: Room temperature 25° C.

Specifically, the heated and thermally cured test specimens were cut out and formed i nto disk-shaped samples with a diameter of 12 mm and a thickness of about 1.0 mm, and then the thermal conductivity was measured using the measurement device TC-7000.

### <Ftir Measurement>

Next, FTIR analysis was performed for the treated particles obtained in Example 9, Comparative Example 9, and Comparative Example 10.

In order to analyze the anchoring state of the surface treatment agent, the treated particles were washed with methanol, and the bonding state and self-condensation state of the particles were analyzed using a diffuse FTIR (FT/IR6300 manufactured by JASCO Corporation).

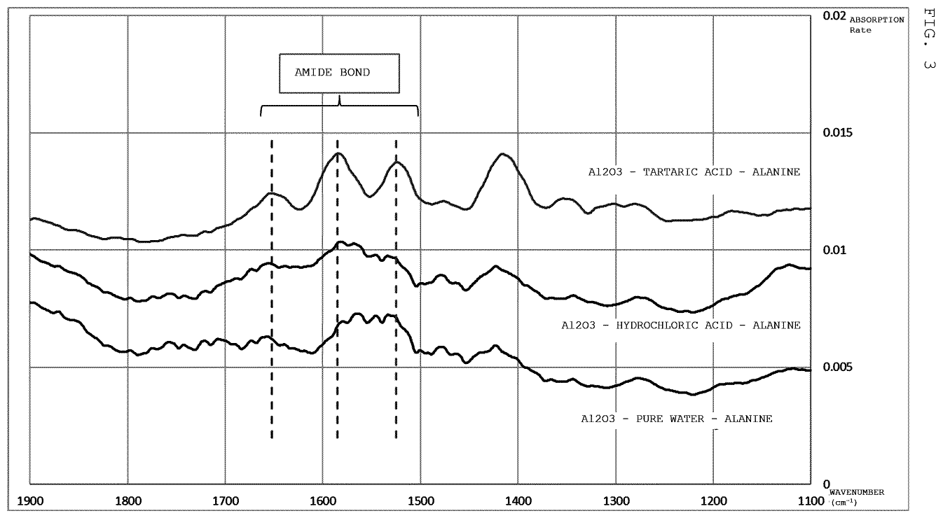

The obtained FTIR spectra are shown in FIG. 3. As a result of the analysis, the absorption peaks of alanine were observed in the particles pre-treated with the organic acid, tartaric acid (Example 9), while no absorption peaks attributable to alanine were observed in the particles acidified with hydrochloric acid (Comparative Example 10) or in the particles that were pre-treated only with pure water and not pre-treated (Comparative Example 9). This confirmed that the surface treatment agent in a self-condensed state was fixed to the surface of the particles pre-treated with the organic acid.

These absorption peaks of alanine indicate the bonding state of alanine in the pre-treatment step for aluminum oxide, indicating the presence of amide bond, which is the bonding of alanine, by pre-treatment with the organic acid.

TABLE 1

| | | core | | | | Volume | Thermal | Autoclave |
|---|---|---|---|---|---|---|---|---|
| | Filler | particle | Pre- | | | fraction | conductivity | test Water |
| | composition | size (μm) | treatment | Organic acid | Post-treatment agent | (%) | (W/m/K) | absorption (%) |
| Example 1 | AlN | 30 | Performed | Tartaric acid | 3-Aminopropyltriethoxysilane | 63 | 3.8 | 0.38 |
| Example 2 | AlN | 30 | Performed | Lactic acid | 3-Isocyanatopropyltriethoxysilane | 63 | 3.5 | 0.45 |
| Comparative | AlN | 30 | Not | — | 3-Aminopropyltriethoxysilane | 55 | 2.2 | 0.60 |
| Example 1 | | | performed | | | | | |
| Comparative | AlN | 30 | Performed | Hydrochloric | 3-Aminopropyltriethoxysilane | 55 | 2.0 | 0.70 |
| Example 2 | | | | acid | | | | |
| Example 3 | MgO | 10 | Performed | Tartaric acid | Alanine | 60 | 2.8 | 0.40 |
| Example 4 | MgO | 10 | Performed | Lactic acid | 3-Aminopropyltriethoxysilane | 60 | 2.9 | 0.36 |
| Comparative | MgO | 10 | Not | — | Alanine | 55 | 1.9 | 1.93 |
| Example 3 | | | performed | | | | | |
| Comparative | MgO | 10 | Performed | Hydrochloric | Alanine | 55 | 1.7 | 2.11 |
| Example 4 | | | | acid | | | | |
| Example 5 | BN | 5 | Performed | Tartaric acid | Glycine | 59 | 2.4 | 0.64 |
| Example 6 | BN | 5 | Performed | Lactic acid | Glycine | 59 | 2.4 | 0.60 |
| Comparative | BN | 5 | Not | — | Glycine | 55 | 1.7 | 1.01 |
| Example 5 | | | performed | | | | | |
| Comparative | BN | 5 | Performed | Hydrochloric | Glycine | 55 | 1.9 | 0.88 |
| Example 6 | | | | acid | | | | |
| Example 7 | SiC | 10 | Performed | Tartaric acid | Cysteine | 55 | 3.2 | 0.42 |
| Example 8 | SiC | 10 | Performed | Lactic acid | N-Phenyl-3-aminopropyltrimethoxysilane | 55 | 3.4 | 0.35 |
| Comparative | SiC | 10 | Not | — | Cysteine | 50 | 1.7 | 0.88 |
| Example 7 | | | performed | | | | | |
| Comparative | SiC | 10 | Performed | Hydrochloric | Cysteine | 53 | 2.4 | 0.75 |
| Example 8 | | | | acid | | | | |

TABLE 2

| | | core | | | | Volume | Thermal | Autoclave test |
|---|---|---|---|---|---|---|---|---|
| | Filler | particle | Pre- | | | fraction | conductivity | Water |
| | composition | size (μm) | treatment | Organic acid | Post-treatment agent | (%) | (W/m/K) | absorption (%) |
| Example 9 | Al2O3 | 10 | Performed | Tartaric acid | Alanine | 55 | 2.1 | 0.40 |
| Example 10 | Al2O3 | 10 | Performed | Salicylic acid | 3-Isocyanatopropyltriethoxysilane | 55 | 2.2 | 0.35 |
| Comparative | Al2O3 | 10 | Not | — | Alanine | 51 | 1.4 | 1.33 |
| Example 9 | | | performed | | | | | |
| Comparative | Al2O3 | 10 | Performed | Hydrochloric acid | Alanine | 51 | 1.3 | 1.40 |
| Example 10 | | | | | | | | |
| Example 11 | Si3N4 | 10 | Performed | Tartaric acid | Aspartic acid | 57 | 2.0 | 0.29 |
| Example 12 | Si3N4 | 10 | Performed | Gallic acid | Aspartic acid | 57 | 2.0 | 0.29 |
| Comparative | Si3N4 | 10 | Not | — | Aspartic acid | 52 | 1.2 | 1.35 |
| Example 11 | | | performed | | | | | |
| Comparative | Si3N4 | 10 | Performed | Hydrochloric acid | Aspartic acid | 52 | 1.4 | 1.25 |
| Example 12 | | | | | | | | |
| Example 13 | Si | 10 | Performed | Tartaric acid | N-2-(Aminoethyl)-3- | 55 | 1.7 | 0.74 |
| | | | | | aminopropylmethyldimethoxysilane | | | |
| Example 14 | Si | 10 | Performed | Hydrochloric acid | N-2-(Aminoethyl)-3- | 55 | 1.8 | 0.70 |
| | | | | | aminopropylmethyldimethoxysilane | | | |
| Comparative | Si | 10 | Not | — | N-2-(Aminoethyl)-3- | 50 | 1.2 | 1.54 |
| Example 13 | | | performed | | aminopropylmethyldimethoxysilane | | | |
| Comparative | Si | 10 | Performed | Hydrochloric acid | N-2-(Aminoethyl)-3- | 52 | 1.3 | 1.20 |
| Example 14 | | | | | aminopropylmethyldimethoxysilane | | | |
| Example 15 | SiO2 | 10 | Performed | Tartaric acid | 3-Aminopropyltriethoxysilane | 58 | 1.6 | 0.21 |
| Example 16 | SiO2 | 10 | Performed | Lactic acid | 3-Aminopropyltriethoxysilane | 58 | 1.6 | 0.21 |
| Comparative | SiO2 | 10 | Not | — | 3-Aminopropyltriethoxysilane | 55 | 1.3 | 0.97 |
| Example 15 | | | performed | | | | | |
| Comparative | SiO2 | 10 | Performed | Hydrochloric acid | 3-Aminopropyltriethoxysilane | 55 | 1.4 | 0.95 |
| Example 16 | | | | | | | | |

What is claimed is:

1. A method for producing a resin additive, comprising:
a mixing step of mixing inorganic particles, an organic acid, and a pH adjusting agent to obtain a mixture having a pH of 5 or more and 9 or less,
a pre-treatment step of treating a surface of the inorganic particles with the organic acid to form a surface treatment layer having a functional group; and
a post-treatment step of treating the inorganic particles having the surface treatment layer formed thereon with a nitrogen-containing post-treatment agent to form a post-treatment layer on a surface of the inorganic particles.

2. The method for producing a resin additive according to claim 1, wherein the organic acid is a hydroxycarboxylic acid, and the functional group is a carboxyl group.

3. The method for producing a resin additive according to claim 1, wherein the organic acid is at least one selected from the group consisting of tartaric acid, lactic acid, hydroxybutyric acid, citric acid, glycolic acid, malic acid, and an aromatic hydroxycarboxylic acid.

4. The method for producing a resin additive according to claim 1, wherein the inorganic particles are of at least one selected from the group consisting of silica, alumina, silicon carbide, magnesium oxide, boron nitride, and aluminum nitride.

5. The method for producing a resin additive according to claim 1, wherein the post-treatment agent is at least one selected from the group consisting of a silane coupling agent having an amino group or an isocyanate group, and an amino acid having an amino group and a carboxylic acid group.

6. The method for producing a resin additive according to claim 1, wherein
the organic acid is at least one selected from the group consisting of tartaric acid, lactic acid, hydroxybutyric acid, citric acid, glycolic acid, malic acid, and an aromatic hydroxycarboxylic acid, and
the post-treatment agent is at least one selected from the group consisting of an amino acid, an amino group-containing silane coupling agent, and an isocyanate group-containing silane coupling agent.

7. The method for producing a resin additive according to claim 1, wherein the pH adjusting agent comprises ammonium carbonate.

8. The method for producing a resin additive according to claim 1, wherein the pre-treatment step comprises a heating step of heating the mixture to 70° C. or higher and 95° C. or lower.

9. The method for producing a resin additive according to claim 8, wherein the pre-treatment step comprises a solution preparing step of adding a solution containing triethanolamine to particles obtained in the heating step to obtain a preparation solution, and removing a solvent from the preparation solution to obtain the inorganic particles.

10. A method for producing an inorganic particle-containing resin composition, comprising a step of mixing and kneading the resin additive obtained by the method according to claim 1 with a resin.

11. A resin additive, comprising
inorganic particles, a surface treatment layer formed on a surface of the inorganic particles, and a post-treatment layer formed on a surface of the surface treatment layer, wherein
the post-treatment layer is formed with a nitrogen atom-containing post-treatment agent.

12. The resin additive according to claim 11, wherein
the surface treatment layer comprises at least one organic acid selected from the group consisting of tartaric acid, lactic acid, hydroxybutyric acid, citric acid, glycolic acid, malic acid, and an aromatic hydroxycarboxylic acid, and
the post-treatment layer comprises at least one post-treatment agent selected from the group consisting of an amino acid, an amino group-containing silane coupling agent, and an isocyanate group-containing silane coupling agent.

13. An inorganic particle-containing resin composition comprising the resin additive according to claim 11 and a resin.
